(19) United States
(12) Patent Application Publication
(10) Pub. No.: US 2025/0241274 A1
(43) Pub. Date: Jul. 31, 2025

(54) SHAFTLESS AUGER WITH ADJUSTABLE ANCHOR

(71) Applicant: CTB, Inc., Milford, IN (US)

(72) Inventors: Collin Marshall, Milford, IN (US); Frank Luttels, Beesel (NL); Todd Martin, Milford, IN (US)

(21) Appl. No.: 19/038,563

(22) Filed: Jan. 27, 2025

Related U.S. Application Data
(60) Provisional application No. 63/625,753, filed on Jan. 26, 2024.

(51) Int. Cl. A01K 5/02

(52) U.S. Cl. CPC A01K 5/0258; A01K 5/0225

(57) ABSTRACT

The present disclosure provides for a shaftless auger with adjustable anchor system comprising a hopper, a boot, a trough, a motor, a coreless/shaftless auger, and an anchor assembly comprising an adjustable anchor and a threaded adjustment rod. Material deposited into the hopper is gravitationally dispensed into the boot, where it fits between flights of the auger. The motor provides a rotational spin to the auger, which pushes the material longitudinally out of the boot and along a length of the trough. Moving the adjustable anchor longitudinally along the adjustment rod alters a tension on the shaftless auger and alters the amount of material that can fit between flights of the auger. When the adjustable anchor is moved forwards a dispersal volume deposited by the auger per foot of trough is reduced. Moving the anchor shaft backwards increases the dispersal volume.

### CROSS REFERENCE TO RELATED APPLICATIONS

This application claims priority to United States Utility Provisional Application No. 63/625,753 filed on Jan. 26, 2024, which is hereby incorporated by reference in its entirety for all purposes.

### TECHNICAL FIELD

The present disclosure relates generally to the field of shaftless augers. Specifically, the present disclosure relates to a livestock feed auger with an adjustable anchor.

### BACKGROUND

Livestock feeders are often utilized to hold, dispense, and otherwise provide animal feed to numerous animals at the same time. Traditional feeders generally comprise a hopper, a boot, and a trough. Animal feed is dispensed into the hopper, which generally has tapered sides to funnel the feed out of the bottom of the hopper and into the boot. Feed deposited into the boot then flows into a feeding trough that extends radially away from the boot. In some instances, an auger lays within the trough, extends into the boot, and pulls the feed along the length of the trough.

It is important to distribute feed universally along a length of the feed trough to ensure uniform amounts of food are distributed to all the animals that come to eat out of the trough. The desired amount of feed dispensed per foot of trough, or feed volume, is dependent upon a variety of factors, such as the type of animal and the desired amount that a user wishes each individual animal to eat. For instance, because male breeder chickens are not used for meat or egg production but are instead used only for fertilization purposes, they are typically fed just enough to keep them healthy, but not so much that they become overweight. Male breeder chickens are thus fed less than their female counterparts, and the feed volume is often limited to around a half a pound of feed per foot.

A desired feed volume may be obtained by adjusting a feed flow rate (i.e., the rate at which the feed moves into the trough), and/or by adjusting the speed of the auger that pulls the feed along the length of the trough. The feed flow rate is in turn dependent upon the type of feed, the size of the opening from the hopper into the boot, the size of the aperture from the boot into the trough, and the available space between the blades, or flights, of the auger. Feed volume is thus also determined by the size of the aperture from the boot into the trough, and the available space between the flights of the auger. For instance, certain types of feed may flow faster into the boot and through the aperture than others, depending on the shape, consistency, density, and/or moisture content of the feed, resulting in a feed volume that is higher, when all other variables are the same, than the feed volume that results from feed that flows slower into the trough.

Adjustments to flow rate, and thereby to feed volume, have traditionally been limited by the ability to change parts within the feeder. One way to control the rate is to adjust a size of a doorway between the hopper and the boot, thereby adjusting the rate at which gravity may pull feed into the boot. Another method is to adjust the size of an aperture between the boot and the trough. Yet another method is to introduce one or more baffles within the hopper, where the baffles act to restrain the flow of feed through the feeder, or to adjust the size or steepness of existing baffle(s). However, all the aforementioned methods require replacement of parts within the feeder and are labor and time intensive. Moreover, introducing baffles or minimizing the doorway or aperture size can result in the feed clumping up, or bridging, or otherwise clogging up in the feeder, resulting in poor feed flow and inconsistent feed volume along the length of the trough.

Accordingly, there is an unmet need in the prior art for an improved livestock feeder that allows for immediate or quick adjustments to acquire a desired and uniform feed volume based on the type of feed and on the type of animal.

### SUMMARY

The present disclosure provides for an improved shaftless auger with an adjustable anchor system. Preferred embodiments of the shaftless auger are preferably integrated into a feeder system for livestock or poultry. However, it is also contemplated that the shaftless auger and adjustable anchor system may be used in other systems to facilitate conveyance of materials other than animal feed. The shaftless auger and adjustable anchor system preferably includes a hopper, a boot, a trough, a motor, an auger, and an anchor assembly. The anchor assembly preferably comprises an adjustable anchor, an anchor housing, and a threaded adjustment rod. The adjustable anchor in turn may additionally comprise an anchor shaft and an anchor body.

In preferred embodiments, the auger is shaftless, or coreless, and comprises helical flighting wherein flights of the auger are continuous such that a single blade is coiled into a whorled spiral. The auger is affixed to and stretched between the motor and the adjustable anchor via a motor shaft and anchor shaft respectively. Feed or other material deposited into the hopper is gravitationally dispensed into the boot where it fits between the flights of the auger. The motor provides a rotational spin to the auger, which pushes and/or pulls the material caught between the auger flight longitudinally out of the boot and along the length of the trough. Because the auger is coreless, a wavelength between flights of the auger is variable based on a stretch of the auger between the motor and adjustable anchor. The more the auger is stretched, the greater the wavelength, and the greater an amount of material that can fit between the flights of the auger and thus that can be transported along a length of the trough.

The adjustable anchor is preferably adjustably fixed to the adjustment rod. By moving the adjustable anchor longitudinally along the adjustment rod the anchor shaft can be moved forward into the boot or backwards out of the boot. When the anchor shaft is moved forwards into the boot, the anchor shaft takes up space within the boot, thereby limiting the amount of material that can flow into the boot and thence onto the trough. Moreover, moving the anchor forward reduces the amount by which the auger is stretched, and reduces the wavelength between the auger flights. Moving the anchor forward thus limits a volume of material that can fit between the flights of the auger, thereby reducing the volume of material dispensed per unit length along the length of the trough (such that the adjustable anchor is in a “low dispersal position”). Conversely, moving the anchor shaft backwards out of the boot increases space within the boot, increases the amount by which the auger is stretched, increases the amount of material that the auger can carry, and thereby increases the volume of material dispensed per foot of trough (such that the adjustable anchor is in a “high dispersal position”).

A preferred embodiment of the present invention comprises:
A material conveyance system, the system comprising:
   a boot;
   a trough extending radially from the boot and defining a trough length;
   an auger, wherein the auger sits within the trough and extends along the trough length and into the boot;
   a motor, which powers a rotational spin of the auger; and
   an anchor assembly, the anchor assembly comprising:
      an adjustable anchor, the adjustable anchor comprising:
         an anchor shaft; and
         an anchor body; and
      an adjustment rod;
   wherein the auger is stretched between the motor and the anchor shaft;
   wherein material is gravitationally deposited into the boot;
   wherein the rotational spin of the auger moves material out of the boot and longitudinally along the length of the trough;
   wherein the anchor assembly is adjustably fixed to the adjustment rod such that the anchor assembly may be incrementally moved forwards along the adjustment rod and the anchor shaft is moved into the boot, and such that the adjustment rod may be incrementally moved backwards along the adjustment rod and the anchor shaft is moved out of the boot;
   wherein the auger is coreless, comprising helically flighting wherein flights of the auger are continuous such that a single blade is coiled into a whorled spiral;
   wherein moving the anchor shaft into the boot decreases a wavelength between the flights of the auger;
   wherein moving the anchor shaft out of the boot increases the wavelength between flights of the auger.

The present disclosure further provides a method for incrementally adjusting a volume of material dispensed along a length of a trough, the method comprising;
providing a material conveyance system, the material conveyance system comprising:
   a boot;
   a trough extending radially from the boot and defining a trough length;
   an auger, wherein the auger sits within the trough and extends along the trough length and into the boot;
   a motor, which powers a rotational spin of the auger; and
   an anchor assembly, the anchor assembly comprising:
      an adjustable anchor, the adjustable anchor comprising:
         an anchor shaft; and
         an anchor body;
      a threaded adjustment rod; and
      at least one anchor nut affixed to the adjustable anchor;
   wherein the auger is stretched between the motor and the anchor shaft;
   wherein the rotational spin of the auger moves material out of the boot and longitudinally along the length of the trough;
   wherein the anchor assembly is adjustably fixed to the adjustment rod such that the anchor assembly may be incrementally moved forwards along the adjustment rod and the anchor shaft is moved into the boot, and such that the adjustment rod may be incrementally moved backwards along the adjustment rod and the anchor shaft is moved out of the boot;
   wherein moving the anchor shaft into the boot decreases material a wavelength between flights of the auger; and
   wherein moving the anchor shaft out of the boot increases the wavelength between the flights of the auger;
filling the boot with material;
rotationally turning the threaded adjustment rod, wherein:
   a clockwise rotation of the threaded adjustment rod screws the threaded adjustment rod into the anchor nut, thereby moving the anchor assembly forwards along the threaded adjustment rod;
   a counterclockwise rotation of the threaded adjustment rod screws the threaded adjustment rod backwards through the anchor nut, thereby moving the anchor assembly backwards along the threaded adjustment rod; and
turning on the motor, commencing the rotational spin of the auger.

The present disclosure further provides a method for incrementally adjusting a volume of material dispensed along a length of a trough, the method comprising:
providing a material conveyance system, the material conveyance system comprising:
   a boot;
   a trough extending radially from the boot and defining a trough length;
   an auger, wherein the auger sits within the trough and extends along the trough length and into the boot;
   a motor, which powers a rotational spin of the auger; and
   an anchor assembly, the anchor assembly comprising:
      an adjustable anchor, the adjustable anchor comprising:
         an anchor shaft; and
         an anchor body;
      a threaded adjustment rod; and
      at least one anchor nut affixed to the adjustable anchor;
   wherein the auger is stretched between the motor and the anchor shaft;
   wherein the rotational spin of the auger moves material out of the boot and longitudinally along the length of the trough;
   wherein the anchor assembly is adjustably fixed to the adjustment rod such that the anchor assembly may be incrementally moved forwards along the adjustment rod and the anchor shaft is moved into the boot, and such that the adjustment rod may be incrementally moved backwards along the adjustment rod and the anchor shaft is moved out of the boot;
   wherein moving the anchor shaft into the boot decreases material a wavelength between flights of the auger; and
   wherein moving the anchor shaft out of the boot increases the wavelength between the flights of the auger;
filling the boot with material;
rotationally turning the threaded adjustment rod, wherein:
   a counter-clockwise rotation of the threaded adjustment rod screws the threaded adjustment rod into the anchor nut, thereby moving the anchor assembly forwards along the threaded adjustment rod;
   a clockwise rotation of the threaded adjustment rod screws the threaded adjustment rod backwards through the anchor nut, thereby moving the anchor assembly backwards along the threaded adjustment rod; and
turning on the motor, commencing the rotational spin of the auger.

### BRIEF DESCRIPTION OF THE DRAWINGS

The invention will be more fully understood by referring to the following Detailed Description of Specific Embodiments in conjunction with the Drawings, of which:

FIG. 1 is a perspective view of a material conveyance system provided in accordance with an embodiment of the current disclosure.

FIG. 2 is a cross-section view of a section of the material conveyance system of FIG. 1, comprising a hopper, boot, trough, auger, and anchor assembly, provided in accordance with an embodiment of the current disclosure.

FIG. 3 is a side perspective view of a hopper and boot comprising a material conveyance system, provided in accordance with an embodiment of the current disclosure.

FIG. 4 is a schematic cross-section of the material conveyance system of FIG. 1, provided in accordance with an embodiment of the current disclosure.

FIG. 5 is a top view of an auger and trough of the material conveyance system of FIG. 1, provided in accordance with an embodiment of the current disclosure.

FIG. 6A is a perspective view of the auger of FIG. 4, provided in accordance with an embodiment of the current disclosure.

FIG. 6B is a front view of the auger of FIG. 6A, provided in accordance with an embodiment of the current disclosure.

FIG. 7 is a perspective view of the material conveyance system of FIG. 4, illustrating the auger and a motor, and provided in accordance with an embodiment of the current disclosure.

FIG. 8 is a perspective view of the anchor assembly of FIG. 2, provided in accordance with an embodiment of the current disclosure.

FIG. 9 is a perspective side view of the anchor assembly of FIG. 8, provided in accordance with an embodiment of the current disclosure.

FIG. 10 is a top perspective view of the anchor assembly of FIG. 8, provided in accordance with an embodiment of the current disclosure.

FIG. 11 is a perspective side view of the anchor assembly of FIG. 8, without the anchor and adjustment rod housings and boot, provided in accordance with an embodiment of the current disclosure.

FIG. 12 is a perspective view of the boot of FIG. 2, provided in accordance with an embodiment of the current disclosure.

FIG. 13 is a perspective view of a material conveyance system comprising an anchor assembly, provided in accordance with an embodiment of the current disclosure.

FIG. 14 is a perspective view of the material conveyance system and anchor assembly of FIG. 13, without an anchor housing and adjustment rod housing, provided in accordance with an embodiment of the current disclosure.

FIG. 15 is a perspective side view of an anchor body, support member, and at least one anchor nut comprising the anchor assembly of FIG. 13, provided in accordance with an embodiment of the current disclosure.

FIG. 16 is a perspective back/side view of the anchor body, support member, and at least one anchor nut of FIG. 15, provided in accordance with an embodiment of the current disclosure.

FIG. 17 is a cross-section side view of the adjustable anchor, boot, and auger of FIG. 2, wherein the adjustable anchor is in a high dispersal position, provided in accordance with an embodiment of the current disclosure.

FIG. 18 is a cross-section side view of the adjustable anchor, boot, and auger of FIG. 2, wherein the adjustable anchor is in an intermediate dispersal position, provided in accordance with an embodiment of the current disclosure.

FIG. 19 is a cross-section side view of the anchor assembly of FIG. 13, wherein an adjustable anchor is in an intermediate material dispersal position, provided in accordance with an embodiment of the current disclosure.

FIG. 20 is a cross-section side view of the adjustable anchor, boot, and auger of FIG. 2, wherein the adjustable anchor is in a low dispersal position, provided in accordance with an embodiment of the current disclosure.

FIG. 21 is a cross-section side view of the anchor assembly of FIG. 13, wherein an adjustable anchor is in a low dispersal position, provided in accordance with an embodiment of the current disclosure.

FIG. 22 is a schematic illustrating a method for using a material conveyance system and adjustable anchor, provided in accordance with embodiments of the current disclosure.

### DETAILED DESCRIPTION OF SPECIFIC EMBODIMENTS

Embodiments of the present invention relate generally to an improved shaftless auger and adjustable anchor. In some embodiments, the shaftless auger and adjustable anchor are utilized within a livestock feeder. However, it is also contemplated that in some embodiments, the shaftless auger and adjustable anchor are used within other material conveyance systems known in the art which utilize an auger to dispense materials. The present disclosure describes, in detail, specific embodiments with the understanding that the present invention may be susceptible to embodiments in different forms, and that the present disclosure is considered an exemplification of the principles of the invention and is not intended to limit the invention to that described herein. Notwithstanding different embodiments with different shaped components, the functions and functional relationships between components of the present disclosure are the same or similar across the described embodiments, and the same reference numerals are used to describe those components.

This disclosure relates to material conveyance systems in general, and descriptions of animal feeder conveyance systems are used for exemplary purposes and to highlight preferred embodiments. Accordingly, while the disclosure relates to the conveyance of materials in general, the use of the term “feed” may be used throughout the disclosure to refer to animal feed specifically, or it may be used interchangeably with the term “materials” to refer to granular, heterogeneous, or fluid materials that may be transported by the material conveyance systems disclosed.

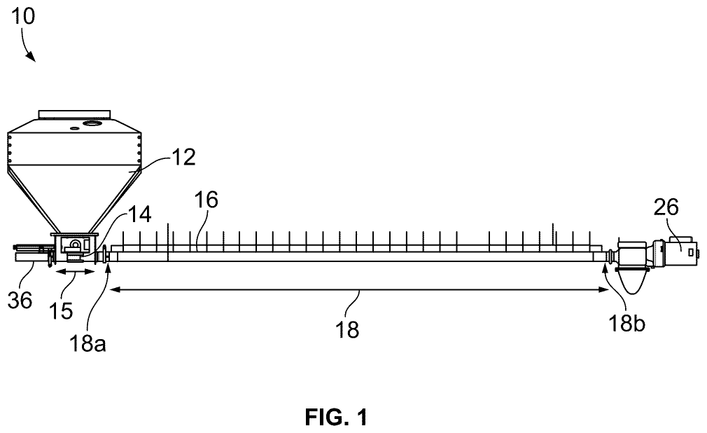

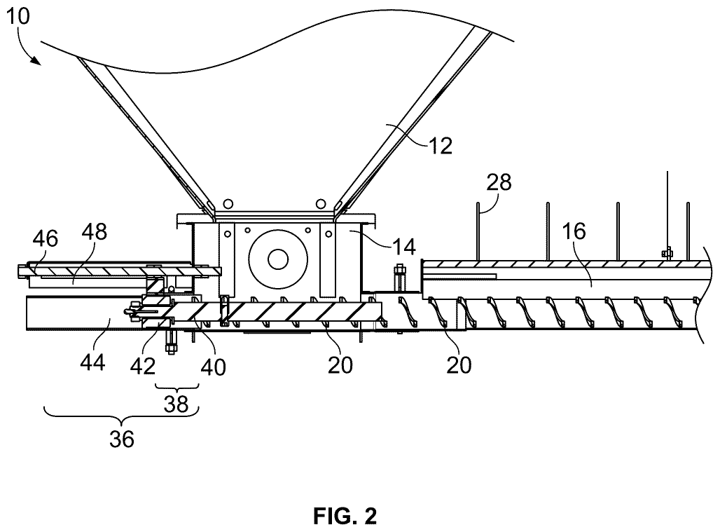

FIGS. 1 and 2 illustrate a material conveyance system 10, provided in accordance a preferred embodiment of the current disclosure. FIG. 1 is a broad perspective view of the material conveyance system 10, which comprises a hopper 12, a boot 14 continuous with the hopper 12, a trough 16 extending radially from the boot 14, a motor 26, and an anchor assembly 36. The trough 16 defines a trough length 18, and the boot 14 defines a boot length 15. The trough 16 further defines a boot end 18a where the trough 16 is affixed to, or continuous with, the boot 14, and a motor end 18b where the trough 16 abuts the motor 26. The motor 26 powers a rotational spin of an auger 20 (shown in FIG. 2) and is preferably positioned at an end of the trough 16 opposite the boot 14. As shown in cross section in FIG. 2, the auger 20 preferably sits within the trough 16 and extends into the boot 14. The anchor assembly 36 may additionally comprise an adjustable anchor 38 comprising an anchor shaft 40 and an anchor body 42, an anchor housing 44, an adjustment rod 46, and/or an adjustment rod housing 48. In some embodiments, such as those where the material conveyance system 10 comprises a livestock feeder, a plurality of guards 28 may cover the trough 16 to keep animals out of the trough 16 while still allowing the animals to eat the feed deposited along the length 18 of the trough 16.

In some embodiments, the hopper 12 has sloped sides and acts to hold large quantities of granular, heterogeneous, or fluid material, such as animal feed, which is then funneled into the boot 14. The boot 14 comprises a body which defines an aperture (not shown) in a side wall or in a bottom of the boot 14, through which the material may flow into the trough 16. The auger 20 extends along the trough length 18 and into or through the boot 14, and “pulls” the material out of the boot 14 to distribute it along the trough length 18.

As shown in FIGS. 1 and 2, the hopper 12 may be positioned at right angles, or perpendicularly, to the boot 14, such that the material is gravitationally funneled into the boot 14 and is then carried longitudinally along a horizontally oriented trough 16. However, it is also contemplated that in some embodiments the trough 16 may be positioned at an angle, such as in instances when the hopper 12 is positioned outside a barn or chicken house and feed is moved along the trough 16 up into the chicken house or barn where it is deposited into another material conveyance system 10 to be dispensed to the animals.

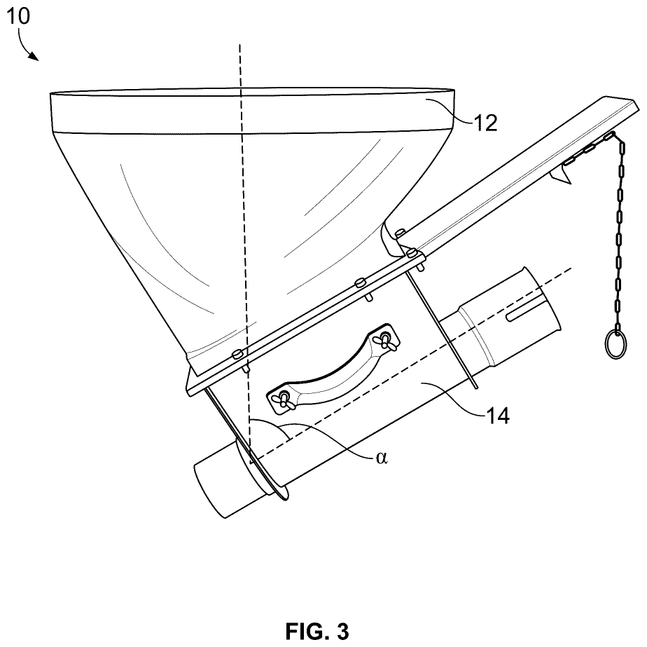

FIG. 3 illustrates the hopper 12 and boot 14 in embodiments where the trough 16 is at a non-horizontal angle. In such instances, the hopper 12 may be positioned at an angle α relative to the boot 14, where the angle α is preferably less than 90°. In some preferred embodiments, the angle α is 60°.

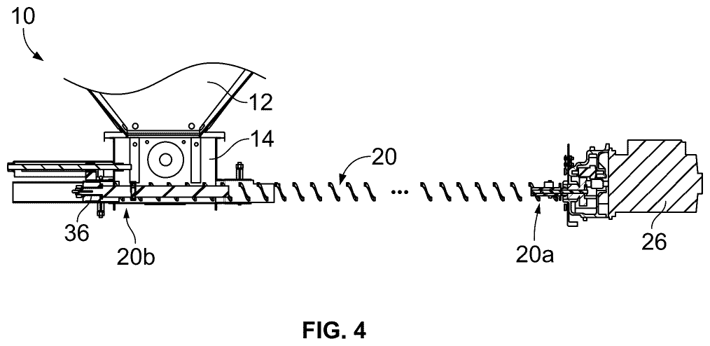

FIG. 4 is a schematic cross-section wherein the trough 16 and a middle portion of the auger 20 is removed to more clearly illustrate the positional relationship of the auger 20, anchor assembly 36, and motor 26. In preferred embodiments, the auger 20 is stretched between the motor 26 and the anchor assembly 36. The auger 20 defines two terminal ends, a motor terminal end 20a which abuts the motor 26, and an anchor terminal end 20b which abuts the anchor assembly 36 within the boot 14.

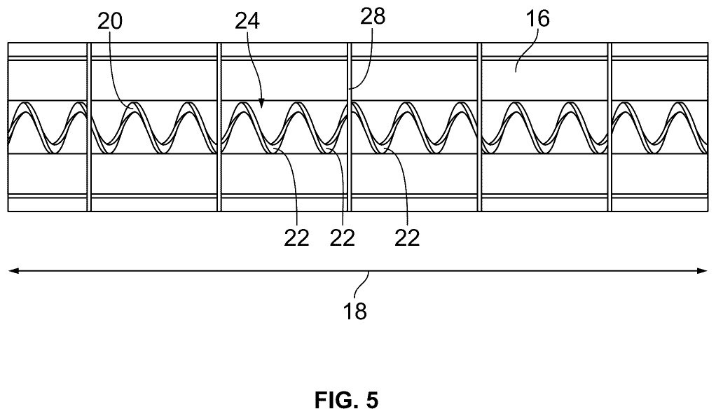

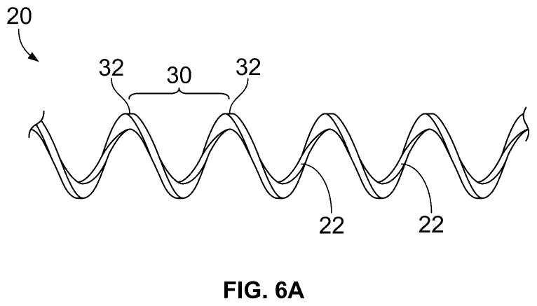

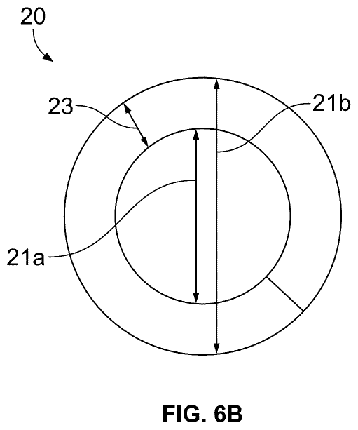

FIG. 5 is a top view of a section of the auger 20 laying within the trough 16. In some embodiments, the auger 20 may sit within a depression, or auger channel 24, that is defined by the trough 16 and which runs along the trough length 18. The auger 20 is preferably shaftless, or coreless. This means that instead of comprising a plurality of blades or flights wrapped around a shaft, the auger 20 comprise helical flighting wherein the flights 22 are continuous and define a single blade coiled into a whorled spiral. Each flight 22 may be understood to define a repeating section of blade between each turn of the whorled spiral. In other words, the flights 22 are the sections of auger 20 between each crest 32 of the auger 20 (the crest 32 is illustrated in FIG. 6a and is further explained above). Feed or material deposited in the hopper 12 and dispensed into the boot 14 thus fits between the flights 22 and is moved lengthwise along the trough 16 with a helical rotation of the auger 20.

FIG. 6a is a perspective view of a section of auger 20 in accordance with embodiments of the current disclosure. Because the auger 20 is preferably coreless, there is no structure to maintain a length of the auger 20. Thus, without a core, the auger 20 may be stretchable such that a wavelength 30 between crests 32 of the auger 20 (i.e., the distance between the flights 22) is adjustable based on a tension placed on the terminal ends 20a, 20b of the auger 20. The greater the tension on the auger 20, the greater the wavelength 30 and the greater the amount of material that can fit between the flights 22 of the auger 20.

FIG. 6b is a perspective view of the auger 20 from a terminal end 20a or 20b, illustrating a core diameter 21a, an auger outer diameter 21b, and a flight width 23. The core diameter 21a is defined by innermost surfaces of the auger flights 22 such that the core diameter 21a has a length that would equate to a diameter of an auger core if the auger 20 were not coreless. The auger outer diameter 21b defines a distance that equates to a wave height of the helical auger 20. In other words, the auger outer diameter 21b defines a distance between outer parameters of the whorled spiral. The flight width 23 defines a width of the flight 22 between the core diameter 21a and the auger outer diameter 21b. Core diameter 21a, outer diameter 21b, and flight width 23 measurements are determinate on a size and model of auger 20. In some embodiments, the core diameter 21a is between 0.80 inches and 2.38 inches. The outer diameter 21b is preferably between 1.44 inches and 5 inches. The flight width 23 is preferably between 1.75 inches and 2.63 inches. However, other auger measurements are contemplated by this disclosure.

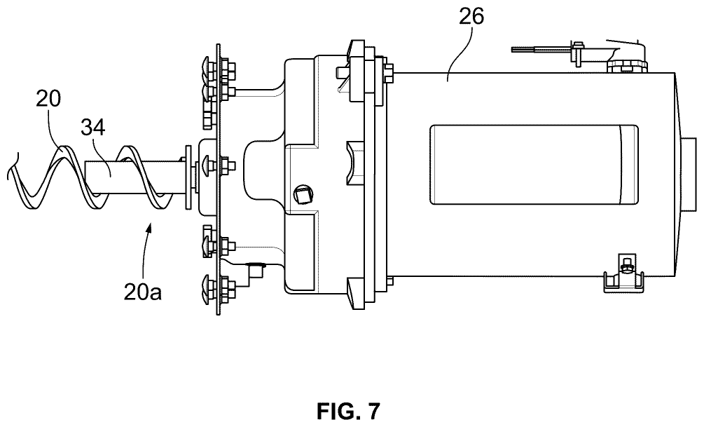

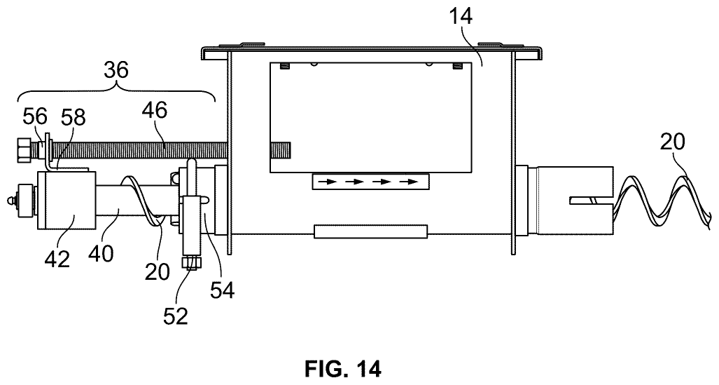

The motor terminal end 20a of the auger 20 is preferably secured to the motor 26 by way of a motor shaft 34, as illustrated in FIG. 7. The auger 20 preferably encircles the motor shaft 34 such that the shaft 34 acts as a core for the auger 20 for a short distance at the motor terminal end 20a. In preferred embodiments, the motor shaft 34 is inserted into a gearhead assembly. In preferred embodiments, the auger 20 is welded to the motor shaft 34. However, it is contemplated that the auger 20 may be secured to the motor shaft 34 by other methods known in the art, such as by industrial adhesives, clamps, bolts, or other methods. Similarly, the anchor terminal end 20b is secured to the anchor shaft 34, as illustrated in FIGS. 14 and 17-21.

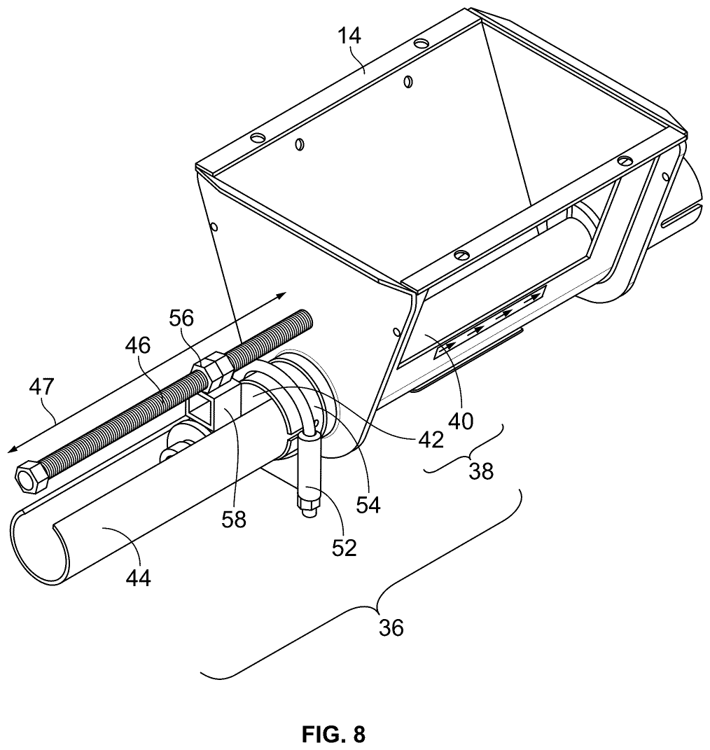

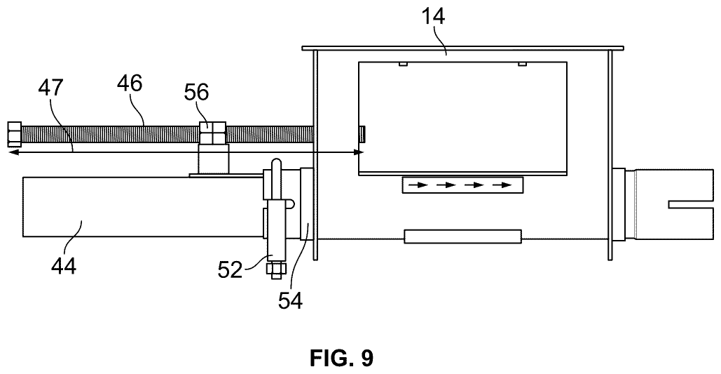

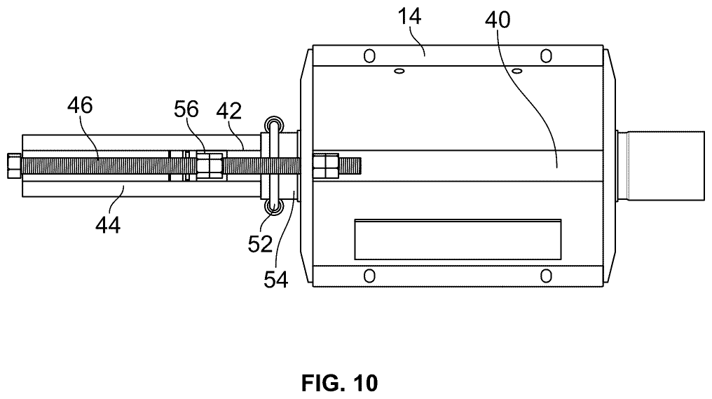

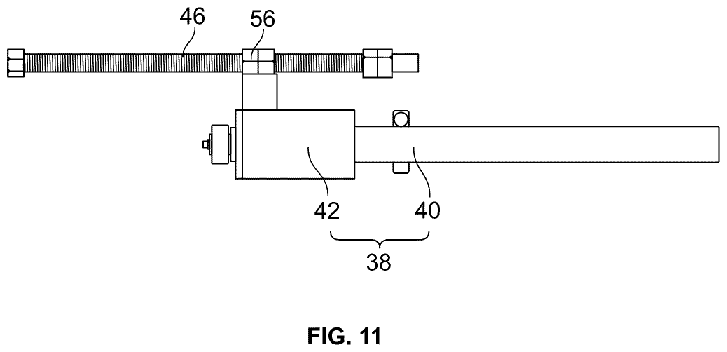

With regards to the anchor assembly 36, illustrated in FIGS. 8-21, the present invention may be susceptible to embodiments in different forms, and it is contemplated that different exemplary embodiments may utilize components of different numbers or shapes. However, the function and purpose of the anchor assembly 36 components remain the substantially the same in different preferred embodiments as detailed infra, and thus descriptions and illustrations of those components utilize the same reference numerals.

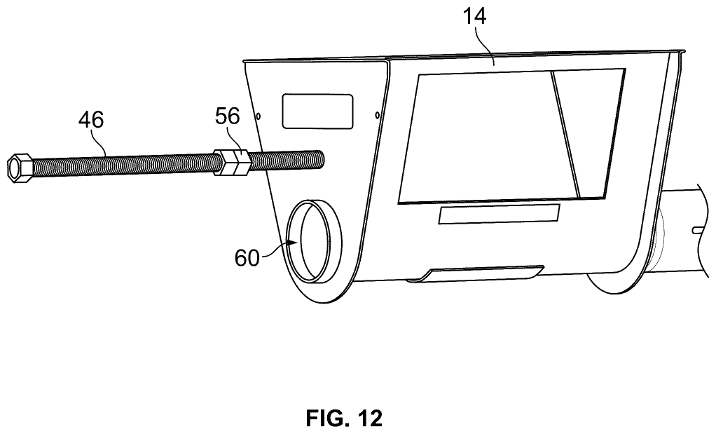

As described supra, and as further illustrated in FIG. 8, the anchor assembly 36 may comprise the adjustable anchor 38 (in turn comprising the anchor shaft 40 and anchor body 42), anchor housing 44, and adjustment rod 46 with rod length 47. The anchor assembly 36 may additionally comprise an anchor clamp 52, an anchor fitting 54, at least one anchor nut 56, and/or a support member 58. The boot 14 may define an anchor hatch 60, as shown in FIG. 12.

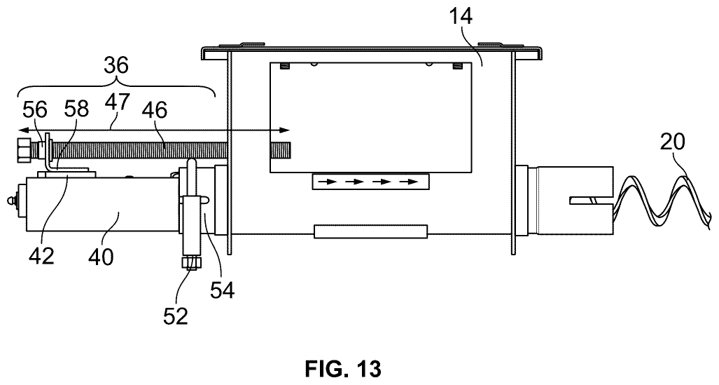

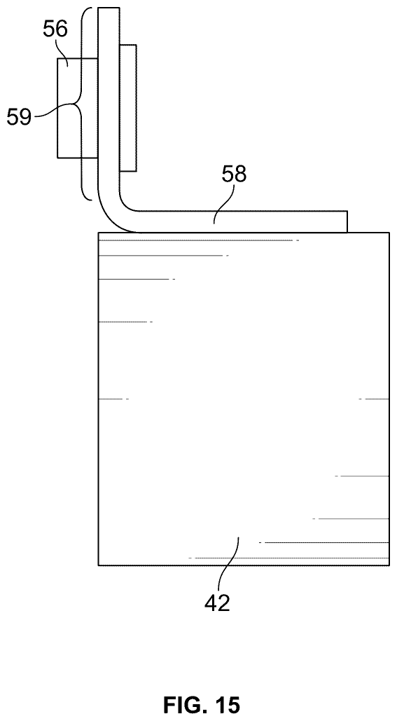

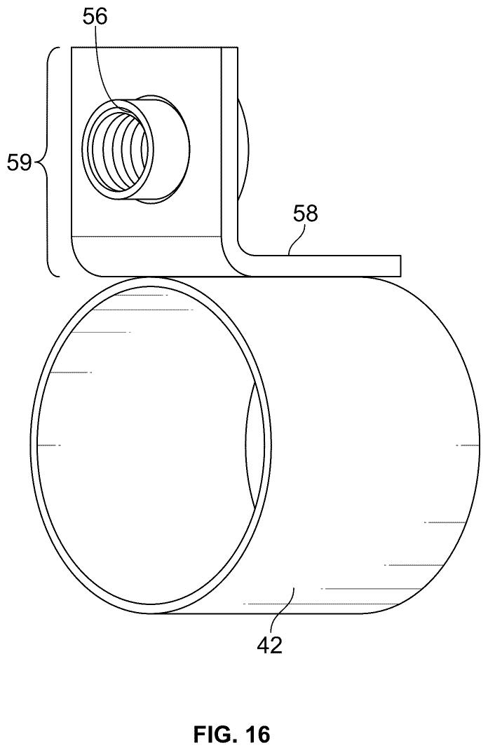

As shown in FIGS. 8-12, 17, 18, and 20, in some embodiments of the anchor assembly 36, the anchor body 42 is adjustably affixed to the threaded adjustment rod 46 via two anchor nuts 56 which are in turn affixed to a top of a block support member 58. In other exemplary embodiments shown in FIGS. 13-16, 19, and 21, the anchor assembly 36 is adjustably affixed to the threaded adjustment rod 46 via a single anchor nut 56, which is in turn fixedly embedded in a vertical leg 59 of an “L” shaped support member 58 (see FIG. 15 for label illustrating the vertical leg 59). FIGS. 15 and 16 more clearly show a positional relationship between the anchor body 42, the support member 58, and the anchor nut 56 in said embodiments. Regardless of anchor nut 56 number or support member 58 shape, in preferred embodiments the anchor nut(s) 56 are fixedly held in place atop the support member 58 and do not rotate in relation to the anchor body 42. Moreover, it is contemplated that the anchor body 42 may be adjustably affixed to the threaded adjustment rod 46 via more than two anchor nuts 56, or that the anchor body 42 may be adjustably affixed to the adjustment rod 46 via other methods known in the art.

Similarly, exemplary support members 58 shown in FIGS. 8-12, 17, 18, and 20 are square, or box, shaped, while exemplary support members 58 shown in FIGS. 13-16, 19, and 21 are “L” shaped, where the at least one anchor nut 56 is fixedly embedded within the vertical leg 59 of the L shaped support member 58. However, other shaped support members 58 are also contemplated by this disclosure, as are embodiments where the anchor body 42 is affixed directly to the adjustment rod 46 without the use of a support member 58.

In any event, in preferred embodiments the anchor body 42 is adjustably fixed to the adjustment rod 46 such that the anchor body 42 sits within the anchor housing 44. In some preferred instances, the adjustment rod 46 is threaded (i.e., the adjustment rod 46 comprises an inclined plane (threads) helically wrapped around a cylindrical rod core) and the adjustable anchor 38 may be fixed to the threaded adjustment rod 46 by way of the at least one anchor nut 56. The at least one anchor nut 56 may in turn be affixed directly to a component of the adjustable anchor 38 such as the anchor body 42, or it may be affixed to the adjustable anchor 38 by way of the support member 58. The threaded adjustment rod 46 may be threaded through the at least one anchor nut 56 such that by rotationally turning the threaded adjustment rod 46, the at least one anchor nut 56 moves along the threads of the threaded adjustment rod 46, thereby moving the attached adjustable anchor 38 in a linear fashion along the rod length 47 of the threaded adjustment rod 46. Movement of the adjustable anchor 38 may be forwards towards the boot 14, or backwards away from the boot 14. Forwards or backwards movement of the anchor nut 56 and adjustable anchor is thus determined by whether the threaded adjustment rod 46 is turned in a clockwise or counterclockwise rotation.

The threaded adjustment rod 46 is in turn bolted or otherwise loosely secured to the boot 14 such that the adjustable anchor 38 is suspended from the adjustment rod 46 and such that the anchor shaft 40 inserts into the boot 14 via the anchor hatch 60 (as shown in FIG. 12). To facilitate movement of the adjustable anchor 38 along the adjustment rod 46, the adjustment rod 46 is preferably secured to the boot 14 in such a way that the adjustment rod 46 can be rotated around a longitudinal axis of the adjustment rod 46 (i.e., such that the adjustment rod 46 may be screwed clockwise and/or counterclockwise). It is therefore preferred that the adjustment rod 46 is not fixedly or rigidly adhered or affixed to the boot 14 but is instead loosely secured in such a manner that the adjustment rod 46 is held in place relative to the boot 14 and adjustable anchor 38, but such that the adjustment rod 46 is still capable of rotational movement within the anchor assembly 36. In preferred embodiments, the threaded adjustment rod 46 is threaded into a hole in the boot 14 and secured with a nut within the boot 14. However, it is also contemplated that the threaded adjustment rod 46 may be secured to the boot 14 via other methods known in the art. Adjustments of the adjustable anchor 38 along the threaded adjustment rod 46 thus move the anchor body 42 longitudinally within the anchor housing 44 and facilitates longitudinal movement of the anchor shaft 40 in or out of the boot 14.

Thus, in preferred embodiments, the position of the adjustable anchor 38 is incrementally adjustable by rotating the adjustable anchor 38, thereby changing a position of the adjustable anchor 38 along the threads of the adjustment rod 46. However, it is contemplated that the position of the adjustable anchor 38 may be adjusted by other methods. For instance, in some embodiments, the adjustment rod 46 is not threaded, and the position of the adjustable anchor 38 along the adjustment rod 46 is secured by clamps, cotter pins, dowel pins, hitch pin clips, or other fasteners known in the art. Moreover, it is contemplated that in some embodiments, the anchor assembly 36 does not comprise an adjustment rod 46 at all, and that the adjustable anchor is incrementally adjustable using pneumatic systems, or is otherwise positionally secured via some other method known in the art.

In some embodiments, as shown in FIGS. 8 and 13, the anchor housing 44 is affixed to the boot 14 by the anchor clamp 52. In some instances, the anchor housing 44 is inserted into the anchor fitting 54, which comprises a pipe extending from the boot 14. The anchor fitting 54 may further define longitudinal cutouts such that a diameter of the anchor fitting 54 is variable based on pressure exerted upon an outward surface of the anchor fitting 54. In such instances, the anchor clamp 52 compresses the anchor fitting 54 such that the longitudinal cutouts are minimized and the diameter of the anchor fitting 54 is reduced, thereby clamping the anchor fitting 54 around the anchor housing 44. The anchor housing 44 is thus secured to the boot 14, while the adjustable anchor 38 may be adjustably moved in a longitudinal direction within the anchor housing 44 by, for instance, sliding the adjustable anchor 38 along the threaded adjustment rod 46. However, it is also contemplated that in some embodiments the anchor housing 44 is secured directly to the boot 14 through welding, adhesives, or other methods known in the art, or that the anchor housing 44 and boot 14 are manufactured as a single unit.

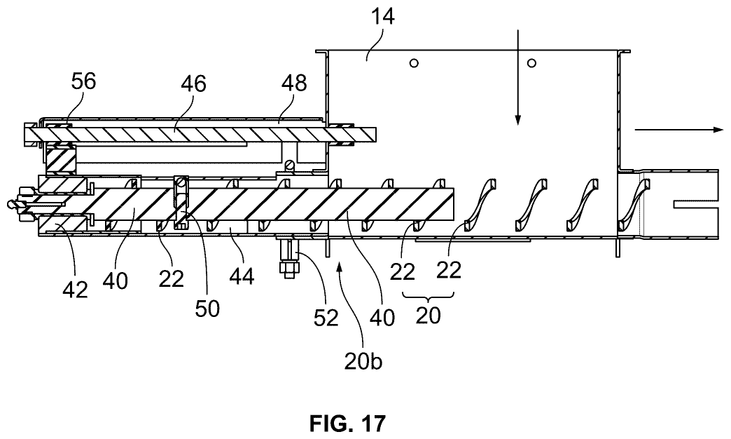

As shown in FIGS. 17-21, once inside the boot 14, the anchor shaft 40 inserts into the anchor terminal end 20b of the auger 20 such that a portion of the auger 20 helically wraps around the anchor shaft 40. A section of the anchor shaft 40 around which the auger 20 helically wraps may be between 5 and 13 inches long. In preferred embodiments, the section of the anchor shaft 40 encircled by the auger 20 is 12 inches long. In some embodiments, the auger 20 is affixed to the anchor shaft 40 such that the anchor shaft 40 rotationally spins at a rate equal to that of the auger 20, as powered by the motor 26. Outside the boot 14, the anchor shaft 40 inserts into the anchor body 42 which holds the shaft 40 in place while allowing its rotational spin. In some embodiments, the auger 20 is affixed to the anchor shaft 40 by way of an auger clamp 50 (see FIGS. 17, 18, and 20) which clamps the anchor shaft 40 to the auger flight 22 circumscribing it. However, it is contemplated that the anchor shaft 40 may be affixed to the auger 20 by other methods, such as by welding the auger flights 22 to the shaft 40, or by adhering the components with high grade adhesives or epoxies. Other methods are also contemplated by this disclosure.

The rate at which the auger 20 spins may be determined by the type and size of motor 26 utilized. Different rates, and thus different motors, may be desired based on the type of material dispensed along the length 18 of the trough 16. For instance, in livestock feeder systems, the type of motor 26 that the system utilizes may be dependent on the type of feed (pellet, mash, etc.), the density of the feed, the type and number of animals being fed, the length of the trough 16, and the amount that a user wishes each animal to eat (i.e., based on the amount of feed that the user wishes to be deposited per foot of trough 16). In preferred embodiments, the motor 26 spins the auger 20 at a rate of between 348 and 696 rpm. More preferably, the material conveyance system 10 utilizes motors 26 that spin at 348 rpm, 425 rpm, or 696 rpm. In a preferred embodiment, the motor 26 spins at a rate of 348 rpm. This preferably results in movement of material at a rate of 40 ft/minute along the length of the trough 16. At this rate, depending on type of material and the wavelength 30 between the auger 20 flights 22, the material conveyance system 10 may preferably move and deliver material at rates between 15 and 220 lbs./minute, with a typical delivery rate of around 50 lbs./minute. However, in other preferred embodiments, the optimal delivery rate is 25 lbs./min.

Material dispersal rates and the volume of material dispensed per unit length of trough (“dispersal volume” or “material density”), are thus influenced by the type of motor 26 and the speed at which it rotates the auger 20. However, because the motor 26 of any particular conveyance system 10 may be limited to a set speed, other methods are necessary to adjust the volume of material dispensed per unit of length, and the dispersal volume may instead by adjusted using the adjustable anchor 38 of the current disclosure.

In other words, embodiments of the current disclosure utilize the anchor assembly 36 to adjust the volume of material dispensed along the trough length 18, regardless of the material flow rate. As shown in FIGS. 17-21, the adjustable anchor 38 may be moved forward into the boot 14 and towards the motor 26 by sliding it along the threaded adjustment rod 46. Conversely, the adjustable anchor 38 may be moved backwards out of the boot 14 and into the anchor housing 44 in the same manner. Moving the adjustable anchor 38 backwards or forwards along the threaded adjustment rod 46 alters the tension on the auger 20, thereby altering the wavelength 30 between the flights 22 and altering the amount of material that can be carried by the auger 20. For instance, sliding the adjustable anchor 38 forward reduces tension on the auger 20, thereby reducing the amount by which the auger 20 is stretched and decreasing the wavelength 30 between the flights 22 of the auger 20. This decreases the amount of feed that may fit within the flights 22 of the auger 20, and thus decreases the amount of feed that the auger 20 can move out of the boot 14 and into the trough 16. Thus, by moving the adjustable anchor 38 forward towards the boot 14, the user decreases the amount of material that can be carried by the auger 20 and decreases the volume of material dispensed per unit length of trough (i.e., lowers the dispersal volume). Conversely, by moving the adjustable anchor backwards and out of the boot 14, the user increases the amount of material that can be carried by the auger 20, thereby increasing the volume of material dispensed per foot of trough and increasing the dispersal volume.

In some embodiments, the auger 20 may be able to stretch between 4 and 20 inches per 100 feet. In more preferred embodiments, the auger 20 may be able to stretch between 8 and 9 inches per 100 feet. In preferred embodiments, the boot length 15 is between 10.9 and 16.6 inches long. In more preferred embodiments, the boot length 15 is 12 inches long. In some embodiments, the trough 16 is composed of multiple segments, which are each ten feet long. Thus, in some embodiments, the trough length 18 is a multiple of ten. In preferred embodiments, the trough 16 is between 300 and 600 feet long. However, it is also contemplated that the trough 16 may be comprised of segments of other lengths or may comprise a single unit. It is also contemplated that the trough 16 may be shorter or longer than the 300-600 range of preferred embodiments. Augers 20 are thus preferably between 10 feet to over 300 feet long. A twin boot system is often used in instances where it is necessary to have between 300 and 600 feet of trough 16. The auger 20 is preferably installed in the trough 16 and boot 14 with an auger length less than that of the trough length 18 and boot length 15 combined and is then stretched between the motor 26 and adjustable anchor 38.

In embodiments comprising livestock feeders, the user can tailor the amount of feed available to the animals per foot of trough 16 by adjusting the dispersal volume. In preferred embodiments, the user stops the auger 20 and the animals eat the feed carried between the flights 22. If the dispersal volume of the feed/material is too high, the auger 20 will carry more feed than it can deposit, and the feed will overflow at the motor end 18b of the trough 16. Too much feed may also be disadvantageous in instances where the user wants to limit the amount that each animal eats. Conversely, if too little feed is introduced, the auger 20 will not carry enough for the number of birds or livestock feeding along the trough length 18. The type of feed introduced to the material conveyance system 10 (i.e., pellets, mash, grain, etc), and the associated size, moisture content, density, etc., will also influence the desired dispersal volume, as it will alter the flow rate, the amount of feed carried between the flights 22 of the auger 20, the amount of excess feed carried by the auger 20, and the amount of feed that the auger 20 will carry and thus disperse along the length 18 of the trough 16.

In exemplary embodiments, where the material conveyance system 10 is used in feeding male breeder chickens, the auger 20 only deposits between 0.4 and 0.9 lbs. of feed per foot of trough 16. In preferred embodiments, the auger 20 deposits 0.67 lbs. of feed per foot. This is because the only agricultural purpose for male breeder chickens is the fertilization of female breeder chickens. The male breeder chicken is not used as a source for poultry meats, nor, as a male chicken, is it used for egg production. Accordingly, male breeder chickens are only fed enough feed to keep them healthy, but not as much as is required by egg laying chickens or meat producing chickens.

However, material conveyance systems 10 for use with other types of poultry or livestock are contemplated by this disclosure, and the material conveyance system 10 specifics outlined in relation to male feeder breeder chickens are not the only embodiments contemplated by this disclosure. Moreover, it is also contemplated that the adjustable anchor assembly 36 of the current disclosure may be utilized in other systems for moving other materials, and that the preferred material densities may be different from those articulated herein. In any event, the issues related to flow rate, the dispersal volume of the feed or material, and adjustability thereof as described in this disclosure exist across auger dispersion systems, and incorporation of an anchor assembly 36 provides a solution to the problems plaguing the prior art regardless of the material conveyance system 10 size, the specifications and length 18 of the trough 16, the specifications of the auger 20, the desired flow rate or feed type, or the type of animal and desired volume of feed per foot distributed in the trough 16.

With regards to adjustment of dispersal volume, FIG. 17 illustrates the adjustable anchor 38 in a position conducive for a high dispersal volume per foot of trough (in a high dispersal position). In the high dispersal position, the adjustable anchor 38 is moved as far back into the anchor housing 44 as possible (and is as fully withdrawn from the boot 14 as possible), thereby minimizing the amount of anchor shaft 40 within the boot 14, minimizing the amount of the auger 20 within the boot 14 that is “cored” with the anchor shaft 40, maximizing the amount of coreless auger 20 within the boot 14, maximizing the wavelength 30 between auger flights 22, and increasing the amount of material dispersed per unit length of trough. When the adjustable anchor 38 is in this high dispersal position, more material can fit between the flights 22 of the auger 20, and the auger 20 can thus move greater volumes of material through the aperture of the boot 14 and into the trough 16. In preferred embodiment, when the anchor 38 is in the high dispersal position, only 3 to 4 inches of the anchor shaft 40 are inserted into the boot 14. However, it is contemplated that in some embodiments, the anchor shaft 38 may be fully withdrawn from the boot 14 and that the amount of anchor shaft 40 inserted into the boot 14 in the high dispersal position may approach 0 inches. In preferred embodiments, positioning the adjustable anchor 38 in the high dispersal position will result in a dispersal volume where material is dispersed at a concentration of 0.785-0.822 lbs. of material per foot of trough 16.

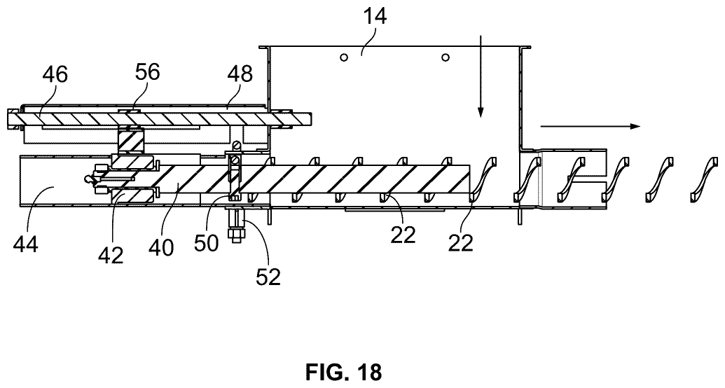

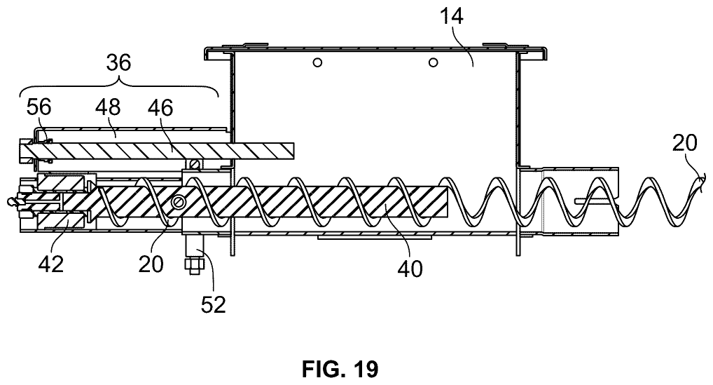

FIGS. 18 and 19 illustrate the adjustable anchor 38 in a position where an intermediate dispersal volume of material is dispensed per unit length of trough (i.e., in an intermediate dispersal position), where the adjustable anchor 38 is partway within the anchor housing 44 and partway within the boot 14. As a result, the tension on the auger 20 is intermediate, creating an intermediate wavelength 30 between the flights 22 of the auger 20. In preferred embodiment, when the anchor 38 is in the intermediate dispersal position, only 6-8 inches of the anchor shaft 40 are inserted into the boot 14. In preferred embodiments, positioning the adjustable anchor 38 in the intermediate dispersal position will result in dispersal of material at a dispersal volume of 0.650-0.654 lbs. of material per foot of trough 16.

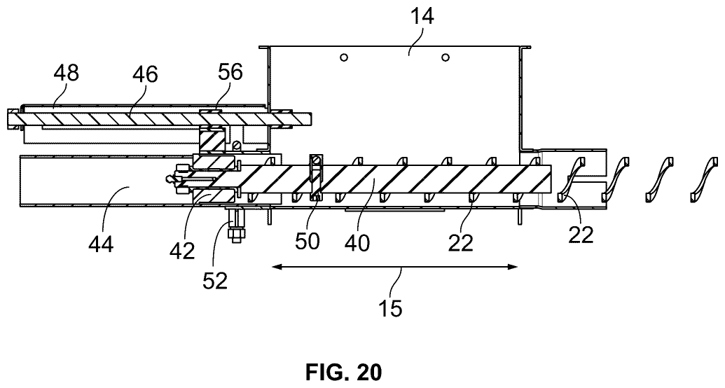

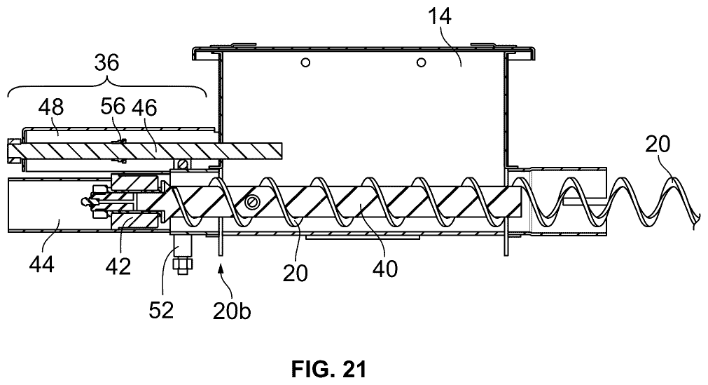

FIGS. 20 and 21 illustrates the adjustable anchor 38 in a position where a low volume of material is dispersed per unit length of trough (i.e., in a low dispersal position yielding a low dispersal volume), where the adjustable anchor 38 is moved as far into the boot 14 as possible, minimizing tension on the auger 20 and minimizing the wavelength 30 between the flights 22. In such embodiments, the majority, or all, of the auger 20 positioned within the boot 14 is cored with the anchor shaft 40. When the adjustable anchor 38 is in this low dispersal position, the anchor shaft 40 uses up space within the boot 14, limiting the amount of material that can fit in the boot 14 and between the flights 22 of the auger 20. Moreover, when the anchor shaft 40 is fully inserted into the boot 14, the entirety of the auger 20 center portion (defined as a core space defined by the flights 22 of the auger 20) within the boot 14 is filled with the anchor shaft 40 and the auger 20. Thus, only peripheral portions of the auger 20 can move material (i.e., only the blades of the flights 22 themselves can move material). Therefore, when the adjustable anchor 38 is in the low dispersal position, the auger 20 can only move limited volumes of material through the aperture of the boot 14 and into the trough 16. It is thus contemplated that in some embodiments the auger shaft 40 is the same length as the boot length 15, and that in the low dispersal position, the entirety of the auger shaft 40 is inserted into the boot 14. In preferred embodiment, when the anchor 38 is in the low dispersal position, 10-12 inches of the anchor shaft 40 are inserted into the boot 14. In preferred embodiments, positioning the adjustable anchor 38 in the low dispersal position will result in a material flow rate such that material is dispersed at a concentration of 0.535-0.557 lbs. of feed per foot of trough 16.

While the aforementioned high, intermediate, and low dispersal positions enumerated above provide specific distances and material concentrations, in preferred embodiment the adjustable anchor 38 may be positioned at any point along the threaded adjustment rod 46. In other words, while three anchor 38 positions and exemplary material densities are used for illustrative purposes above, it is contemplated that the anchor 38 position may be variable, such that the position of the adjustable anchor 38 along the threaded adjustment rod 46 may be changed incrementally on a variable scale to accommodate the different types of material and the desired dispersal volume, density and rate. Accordingly, it is contemplated that the dispersal volumes may similarly be variable. In some embodiments, a distance which the anchor assembly 36 moves to achieve different material dispersal volumes, i.e., the overall adjustment length, equates to the length 15 of the boot 14. Accordingly, in some embodiments the overall adjustment length is between 10.9 and 16.6 inches long. In more preferred embodiments, the overall adjustment length is 12 inches long. However, in other preferred embodiments, the overall adjustment length is less than the length of the boot 14, and accounts for a plateaued high dispersal volume that may occur as the anchor assembly 36 moves backwards out of the boot 14. In such instances, an optimum overall adjustment length may be between 3.5 and 4 inches.

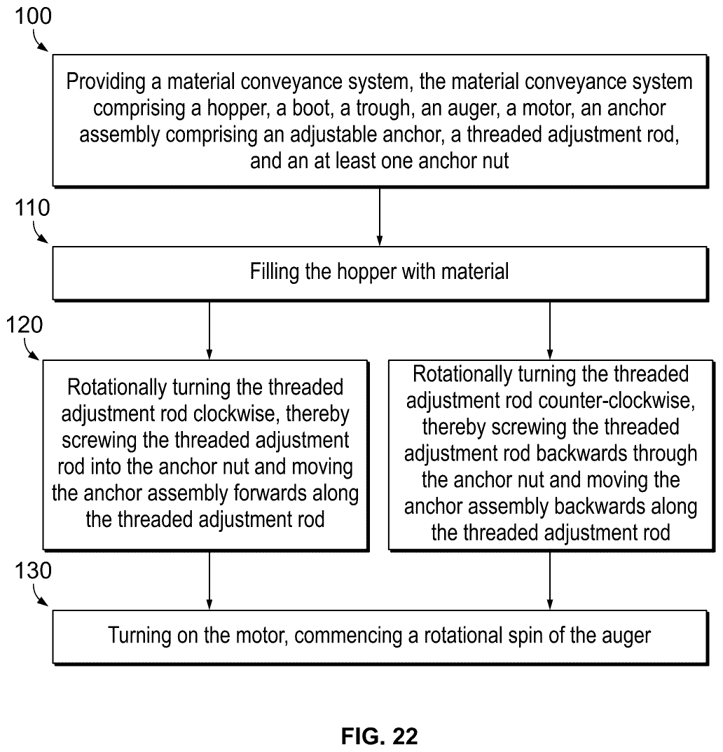

FIG. 22 illustrates a method by which a user may alter the dispersal volume dispersed along the length of a trough 16 in the material conveyance system 10. Step 100 comprises providing the material conveyance system 10 in accordance with the current disclosure, where the material conveyance system 10 comprises the hopper 12, the boot 14, the trough 16, the auger 20, the motor 26, and the anchor assembly 36 comprising the adjustable anchor 38, the threaded adjustment rod 46, and the at least one anchor nut 56. Step 110 comprises filling the hopper 12 with material. In some embodiments where the material conveyance system 10 comprises an animal feeder, the hopper 12 is filled once a day. In some embodiments, the hopper 12 can hold between 100 and 400 lbs. of feed. In preferred embodiments, the hopper 12 can hold 300 lbs. of feed. The material is then gravitationally dispensed into the boot 14. Step 120 of the method comprises rotationally turning the threaded adjustment rod 46 to adjust the volume of material dispensed per foot of trough 16. In some embodiments, by rotationally turning the threaded adjustment rod 46 in a clockwise rotation, the threaded adjustment rod 46 is screwed into the anchor nut 56, thereby moving the anchor assembly 36 forwards along the threaded adjustment rod 46 and decreasing the volume of material dispensed per foot of trough 16 (decreasing the material volume). By rotationally turning the threaded adjustment rod 46 in a counterclockwise rotation, the threaded adjustment rod 46 is screwed backwards out of the anchor nut 56, thereby moving the anchor assembly 36 backwards along the threaded adjustment rod 46 and increasing the volume of material dispensed per foot of trough 16 (increasing the dispersal volume). However, it is also contemplated that in some embodiments a clockwise rotation moves the anchor assembly 36 backwards to increase the material volume, while a counterclockwise rotation moves the anchor assembly 36 forward to decrease material volume. The user then proceeds to step 130 and turns on the motor 26, which commences the rotational spin of the auger 20, pulling the material along the length 18 of the trough 16.

In preferred embodiments, the anchor shaft 40, adjustment rod 46, anchor housing 44, adjustment rod housing 48, and trough 16 are composed of a rigid, durable, moisture and rust resistant material such as galvanized steel, stainless steel, or a rigid plastic. In preferred embodiments the anchor shaft 40 and adjustment rod 46 are composed of stainless steel. Dimensions of the anchor shaft 40 are determinate upon the size of auger 20 utilized and may have a diameter between 0.75 and 1.740 inches, with a preferred diameter of 1.06 inches such that it fits within, and fills, the core diameter 21a of the auger 20. The adjustment rod 46 is preferably between 6 and 13 inches long. In preferred embodiments, the adjustment rod 46 comprises a ½″-13 threaded rod welded to a ½″-13 hex nut. However other types of adjustment rods 46 and other dimensions thereof are contemplated by this disclosure.

The anchor body 42 comprises a bearing wherein the anchor shaft 40 is lubricated and rotates inside two bushings.

In preferred embodiments, as described supra, the trough 16 is between 300 and 600 feet long. However, other lengths are contemplated by this disclosure. The trough 16 is preferably 3.14 inches deep, with an outer width of 5.241 inches. However, other trough 16 dimensions are contemplated by this disclosure. In some embodiments, the auger channel 24 preferably defines a depression in a bottom of the trough 16, or a trough “bulb,” which preferably has a radius of 0.98 inches. However, other bulb dimensions are contemplated, where the bulb dimensions are such that the bulb may encompass augers 20 of other sizes and dimensions. It is also contemplated that some embodiments do not comprise an auger channel 24 and that the auger 20 simply sits within the trough 16.

Moreover, it is also contemplated that in some embodiments the auger 20 is housed within a tube, rather than a trough 16, wherein the tube has a plurality of apertures on sides and/or a bottom of the tube. In such embodiments, the auger 20 pulls/pushes feed along a length of the tube, and material falls through the apertures in the sides and/or bottom of the tube for dispersal.

While the invention is described through the above-described exemplary embodiments, modifications to, and variations of, the illustrated embodiments may be made without departing from the inventive concepts disclosed herein. For example, although specific parameter values, such as dimensions, materials, additives and coatings, may be recited in relation to disclosed embodiments, within the scope of the invention, the values of all parameters may vary over wide ranges to suit different applications.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Although aspects of embodiments may be described with reference to flowcharts and/or block diagrams, functions, operations, decisions, etc. of all or a portion of each block, or a combination of blocks, may be combined, separated into separate operations or performed in other orders.

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. A material conveyance system, the system comprising:
a boot;
a trough extending away from the boot and defining a trough length;
an auger, wherein the auger sits within the trough and extends along the trough length and into the boot;
a motor, which powers a rotational motion of the auger;
an anchor assembly, the anchor assembly comprising:
an adjustable anchor, the adjustable anchor comprising:
an anchor shaft; and
an anchor body; and
an adjustment rod;
wherein the auger is stretched between the motor and the anchor shaft;
wherein material is deposited into the boot;
wherein the rotational movement of the auger moves material out of the boot and longitudinally along the length of the trough;
wherein the anchor assembly is adjustably fixed to the adjustment rod such that the anchor assembly may be incrementally moved forwards along the adjustment rod and the anchor shaft is moved into the boot, and such that the adjustment rod may be incrementally moved backwards along the adjustment rod and the anchor shaft is moved out of the boot;
wherein the auger is coreless, comprising helically flighting wherein flights of the auger are continuous such that a single blade is coiled into a whorled spiral;
wherein moving the anchor shaft into the boot decreases a wavelength between the flights of the auger; and
wherein moving the anchor shaft out of the boot increases the material the wavelength between flights of the auger.

2. The material conveyance system of claim 1, wherein the adjustable anchor is utilized in a livestock feeder.

3. The material conveyance system of claim 1, wherein the auger additionally defines a motor terminal end and an anchor terminal end.

4. The material conveyance system of claim 3, wherein the motor terminal end of the auger is secured to the motor by way of a motor shaft.

5. The material conveyance system of claim 4, wherein the auger helically wraps around the motor shaft.

6. The material conveyance system of claim 4, wherein the anchor terminal end of the auger is secured to the anchor shaft of the adjustable anchor such that the auger is stretched between the motor and the adjustable anchor, creating a tension on the auger.

7. The material conveyance system of claim 6, wherein incrementally moving the adjustable anchor forward such that the anchor shaft is fully inserted into the boot, places the adjustable anchor in a low dispersal position where the auger dispenses material along the length of the trough at a concentration of 0.535-0.557 lbs. of material per foot of trough.

8. The material conveyance system of claim 6, wherein incrementally moving the adjustment anchor backwards such that the anchor shaft is fully withdrawn from the boot, places the adjustable anchor in a high dispersal position where the auger dispenses material along the length of the trough at a concentration of 0.785-0.822 lbs. of material per foot of trough.

9. The material conveyance system of claim 6, wherein incrementally moving the adjustable anchor such that the anchor shaft is inserted 6-8 inches into the boot places the adjustable anchor in an intermediate dispersal position where the auger dispenses material along the length of the trough at a concentration of 0.650-0.654 lbs. of material per foot of trough.

10. The material conveyance system of claim 1, wherein the auger sits within an auger channel defined by the trough.

11. The material conveyance system of claim 1, wherein the adjustment rod is threaded, comprising threads helically wrapped around a cylindrical rod core.

12. The material conveyance system of claim 1, additionally comprising at least one anchor nut secured to the adjustable anchor, wherein the threaded adjustment rod is threaded through the at least one anchor nut such that by rotationally spinning the threaded adjustment rod the at least one anchor nut moves along the threads of the threaded adjustment rod, thereby moving the adjustable anchor in a linear fashion along a length of the threaded adjustment rod.

13. A method for incrementally adjusting a volume of material dispensed along a length of a trough, the method comprising:
providing a material conveyance system, the material conveyance system comprising:
a boot;
a trough extending radially from the boot and defining a trough length;
an auger, wherein the auger sits within the trough and extends along the trough length and into the boot;
a motor, which powers a rotational spin of the auger; and
an anchor assembly, the anchor assembly comprising:
an adjustable anchor, the adjustable anchor comprising:
an anchor shaft; and
an anchor body;
a threaded adjustment rod; and
at least one anchor nut affixed to the adjustable anchor;
wherein the auger is stretched between the motor and the anchor shaft;
wherein the rotational spin of the auger moves material out of the boot and longitudinally along the length of the trough;
wherein the anchor assembly is adjustably fixed to the adjustment rod such that the anchor assembly may be incrementally moved forwards along the adjustment rod and the anchor shaft is moved into the boot, and such that the adjustment rod may be incrementally moved backwards along the adjustment rod and the anchor shaft is moved out of the boot;
wherein moving the anchor shaft into the boot decreases a wavelength between flights of the auger; and
wherein moving the anchor shaft out of the boot increases the wavelength between the flights of the auger;
filling the boot with material;
rotationally turning the threaded adjustment rod, wherein:
a clockwise rotation of the threaded adjustment rod screws the threaded adjustment rod into the anchor nut, thereby moving the anchor assembly forwards along the threaded adjustment rod;
a counterclockwise rotation of the threaded adjustment rod screws the threaded adjustment rod backwards through the anchor nut, thereby moving the anchor assembly backwards along the threaded adjustment rod; and
turning on the motor, commencing the rotational spin of the auger.

14. The method of claim 13, wherein the material conveyance system is utilized in a livestock feeder.

15. The method of claim 13, wherein incrementally moving the adjustment anchor forward such that the anchor shaft is fully inserted into the boot places the adjustable anchor in a low dispersal position where the auger dispenses material along the length of the trough at a concentration of 0.535-0.557 lbs. of material per foot of trough.

16. The material conveyance system of claim 13, wherein incrementally moving the adjustment anchor backwards such that the anchor shaft is fully withdrawn from the boot places the adjustable anchor in a high dispersal position where the auger dispenses material along the length of the trough at a concentration of 0.785-0.822 lbs. of material per foot of trough.

17. The material conveyance system of claim 13, wherein incrementally moving the adjustable anchor such that the anchor shaft is inserted 6-8 inches into the boot places the adjustable anchor in an intermediate dispersal position where the auger dispenses material along the length of the trough at a concentration of 0.650-0.654 lbs. of material per foot of trough.

18. A method for incrementally adjusting a volume of material dispensed along a length of a trough, the method comprising:
providing a material conveyance system, the material conveyance system comprising:
a boot;
a trough extending radially from the boot and defining a trough length;
an auger, wherein the auger sits within the trough and extends along the trough length and into the boot;
a motor, which powers a rotational spin of the auger; and
an anchor assembly, the anchor assembly comprising:
an adjustable anchor, the adjustable anchor comprising:
an anchor shaft; and
an anchor body;
a threaded adjustment rod; and
at least one anchor nut affixed to the adjustable anchor;
wherein the auger is stretched between the motor and the anchor shaft;
wherein the rotational spin of the auger moves material out of the boot and longitudinally along the length of the trough;
wherein the anchor assembly is adjustably fixed to the adjustment rod such that the anchor assembly may be incrementally moved forwards along the adjustment rod and the anchor shaft is moved into the boot, and such that the adjustment rod may be incrementally moved backwards along the adjustment rod and the anchor shaft is moved out of the boot;
wherein moving the anchor shaft into the boot decreases a wavelength between flights of the auger; and
wherein moving the anchor shaft out of the boot increases the wavelength between flights of the auger;
filling the boot with material;
rotationally turning the threaded adjustment rod, wherein:
a counterclockwise rotation of the threaded adjustment rod screws the threaded adjustment rod into the anchor nut, thereby moving the anchor assembly forwards along the threaded adjustment rod;
a clockwise rotation of the threaded adjustment rod screws the threaded adjustment rod backwards through the anchor nut, thereby moving the anchor assembly backwards along the threaded adjustment rod; and
turning on the motor, commencing the rotational spin of the auger.

19. The method of claim 18, wherein the material conveyance system is utilized in a livestock feeder.
